(19) United States
(12) Patent Application Publication
(10) Pub. No.: US 2026/0300688 A1
(43) Pub. Date: Oct. 1, 2026

(54) LOCALLY AND STRUCTURALLY ADAPTIVE NEURAL NETWORK ARCHITECTURE FOR STATISTICALLY HETEROGENOUS DATA

(71) Applicant: Mitsubishi Electric Research Laboratories, Inc., Cambridge, MA (US)

(72) Inventors: Saviz Mowlavi, Cambridge, MA (US); Jonah Botvinick-Greenhouse, Ithaca, NY (US); Wael Ali, Cambridge, MA (US); Mouhacine Benosman, Cambridge, MA (US)

(73) Assignee: Mitsubishi Electric Research Laboratories, Inc., Cambridge, MA (US)

(21) Appl. No.: 19/089,273

(22) Filed: Mar. 25, 2025

(51) Int. Cl. G06N 3/045; G06N 3/098

(52) U.S. Cl. CPC G06N 3/045; G06N 3/098

(57) ABSTRACT

Technology is disclosed herein relating to a feedback artificial intelligence system for performing a task by processing input data from an input space and mapping it to output data in an output space. In an implementation, the system executes a hybrid neural network which includes a global neural network trained to process the input data from any region of the input space and a plurality of local neural networks, each associated with a distinct partition of the input space defined by a trainable window function and trained to process the input data only if the input data falls within the partition. The hybrid neural network generates the output data that integrates the output data of the global neural network and the local neural networks, and the system performs the task based on the mapped output data.

### TECHNICAL FIELD

Aspects of the disclosure are related to the neural network architectures and methods of training and operating neural networks.

### BACKGROUND

Neural network architectures often struggle in complex environments where global effects dominate or overshadow localized variations. In such cases, a model trained on a large-scale dataset may accurately capture overall trends but fail to account for subtle, yet crucial, local deviations. For instance, in climate modeling, a neural network may effectively predict large-scale weather patterns but miss critical microclimatic variations, such as urban heat islands or localized precipitation anomalies. Similarly, in financial forecasting, a model trained on broad economic indicators may fail to detect small yet impactful fluctuations within niche markets or specific asset classes. When local effects are averaged out, the model's ability to make precise, context-sensitive predictions diminishes, leading to suboptimal decision-making in applications that rely on fine-grained distinctions.

Complex environments with global as well as localized phenomena may be addressed by partitioning input data for handling by multiple independent neural networks. However, this approach can lead to fragmented and inconsistent representations of the system being modeled. Because each neural network is trained on a subset of the data, it may develop biases or gaps in understanding that are not properly reconciled at the global level. For example, in supply chain optimization, separate networks handling production, logistics, and demand forecasting may make decisions that conflict due to a lack of shared context. Similarly, in medical diagnostics, partitioning data across networks trained on different patient demographics or disease categories may prevent the model from capturing holistic patient profiles, leading to errors in cross-category diagnoses. Thus, multiple independent neural networks trained in isolation may fail to generalize effectively across diverse conditions.

### SUMMARY

Technology is disclosed herein relating to an artificial intelligence (AI) system which includes an adaptive hybrid neural network architecture. In an implementation, a feedback artificial intelligence system for performing a task by processing input data from an input space and mapping it to output data in an output space includes a processor and a memory storing instructions that, when executed by the processor, cause the system to collect a dataset of inputs from different regions of the input space and execute a hybrid neural network trained to map the input data to the output data. The hybrid neural network includes a global neural network trained to process the input data from any region of the input space and generate corresponding output data and a plurality of local neural networks positioned along a processing path of the input data, wherein each local neural network is associated with a distinct partition of the input space defined by a trainable window function and wherein each local neural network processes the input data and generates corresponding output data only if the input data falls within a designated partition determined by the corresponding window function. The hybrid neural network generates the output data that integrates the output data of the global neural network and the local neural networks, and the system performs the task based on the mapped output data.

Some examples of the technology disclosed here include a method for training a hybrid neural network that dynamically adjusts its architecture for mapping input data from input space to output data in output space. The hybrid neural network includes a global neural network trained to process the input data from any region of the input space and generate corresponding output data and a plurality of local neural networks positioned along a processing path of the input data, each associated with a distinct partition of the input space defined by a trainable window function such that each local neural network processes input data only if it falls within a designated partition determined by a corresponding window function. The training includes monitoring a residual error of the hybrid neural network across the input space. During training, a local neural network is added in a region where the residual error exceeds a first predefined threshold by initializing its window function in a center of that region, and a local neural network is removed in a region where the residual error falls below a second predefined threshold.

Some examples of the technology disclosed herein include a method for adaptively training a neural network to improve performance in complex problem domains. The training includes providing a pretrained global neural network configured to capture large-scale trends over the input space of a dataset and computing residual errors between predictions of the global neural network and corresponding ground-truth values. The training also includes dynamically instantiating local neural networks in response to residual errors exceeding a predefined threshold such that each local neural network is configured to refine predictions in a corresponding region of the input space and training the local neural networks independently or jointly with the global neural network to minimize residual errors in the corresponding regions. The training also includes adjusting the number and spatial placement of the local neural networks during training or inference based on real-time performance analysis, wherein local neural networks are removed from regions where residual errors fall below a predefined threshold and generating final model outputs by combining predictions of the global neural network and the local neural networks such that the contribution of each local neural network is weighted according to a dynamically learned window function defining the spatial coverage of the local network.

Some examples of the technology disclosed herein include an adaptive neural network architecture for executing inference in complex problem domains. The adaptive neural network architecture includes a global neural network configured to generate baseline predictions based on a dataset, or physics-based constraints, or a combination of both and a plurality of local neural networks instantiated dynamically based on precomputed residual errors exceeding a predefined threshold, each local neural network being configured to refine predictions in a corresponding region of the input space; a residual-based error analysis module configured to determine the contribution of each local neural network by computing the deviation between the global neural network's predictions and ground-truth data, or the degree to which the global neural network's predictions violate the physics-based constraints. The adaptive neural network architecture also includes a fusion module configured to integrate predictions from the global neural network and active local neural networks, wherein each local neural network's contribution is weighted according to a dynamically learned window function defining its spatial and contextual relevance and a dynamic local network manager configured to adjust the number and spatial placement of the local neural networks during the training based on the residual errors.

This Summary is provided to introduce a selection of concepts in a simplified form that are further described below in the Detailed Description. It may be understood that this Summary is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for operating a feedback artificial intelligence (AI) system in an implementation.

FIG. 2 illustrates a process for processing input using an adaptive hybrid neural network for performing a task in an implementation.

FIG. 3 illustrates an operational environment for training an adaptive hybrid neural network in an implementation

FIG. 4 illustrates a workflow for training an adaptive hybrid neural network in an implementation.

FIG. 5 illustrates adaptive switching during training of an adaptive hybrid neural network in an implementation.

FIGS. 6A and 6B illustrate applications of an adaptive hybrid neural network for performing tasks.

FIG. 7 illustrates a computing system suitable for implementing the various operational environments, architectures, processes, scenarios, and sequences discussed below with respect to the other Figures.

### DETAILED DESCRIPTION

Many real-world applications require processing input data to perform a task effectively. For example, in airflow modeling, predicting airflow velocity based on temperature measurements is essential for HVAC (heating, ventilation, and air conditioning) control. Similarly, in thermal management, predicting flow patterns helps optimize mechanical designs of heat transfer devices. This task requires an accurate mapping between the input data (e.g., temperature or spatial location) and the desired output.

Hence, the goal of machine learning is to develop a model represented by a neural network:

$${u}_{θ} : {ℝ}^{m} \to {ℝ}^{n}$$

which maps input data x∈ [symbol] ^{m} to output data y∈ [symbol] ⁿ, where [symbol] ^{m} is the input space and [symbol] ⁿ is the output space. This mapping is determined by the architecture of u_{θ} and the trainable parameters θ. After training on a dataset of input-output pairs (xᵢ, yᵢ) using, for example, a regression loss of the form

$${L}_{regression} ( θ ) = \frac{1}{N} {\sum }_{i = 1}^{N} {( {u}_{θ} ( {x}_{i} ) - {y}_{i} )}^{2}$$

the trained model is used to process real-time input data and generate the corresponding output necessary to perform the task.

To train a neural network that maps data from an input space to an output space, a number of machine learning methods assume that there is a stable statistical relationship between the two. This assumption allows the model to generalize from training data to new inputs. However, in many real-world scenarios, this assumption does not hold, particularly when the process to be modeled exhibits multiple distinct regimes, such as in airflow modeling or video anomaly detection. In these cases, the statistical relationship between input and output can vary significantly across different regions of the input space, making it difficult for a single global neural network to learn accurate mapping.

For example, in a typical indoor environment, the relationship between temperature measurements and airflow velocity varies significantly depending on the global temperature setting. At high temperatures, turbulence effects are more pronounced and are likely to cause greater fluctuations in the airflow velocity compared to at low temperatures. If a neural network is trained using data collected at both low and high temperatures, it will learn an averaged relationship between temperature and airflow velocity. However, this global mapping does not accurately capture the fundamental difference in airflow behavior at low or high temperature, leading to errors in airflow velocity predictions. For example, the model may underpredict velocity fluctuations at night when the set temperature is lower, while overpredicting fluctuations during the day. This issue arises because a conventional neural network does not inherently differentiate between different input regions, instead capturing the input-output relationship into a single global function, which fails to reflect the true behavior of systems displaying distinct regimes.

Some embodiments are based on the recognition that Physics-Informed Neural Networks (PINNs) improve generalization by embedding physics-based constraints. Instead of relying solely on data, PINNs incorporate physical governing equations in the form of partial differential equations (PDEs). A PDE indirectly specifies a function u:Ω→ [symbol] ⁿ defined on a domain Ω∈ [symbol] ^{m} with boundary ∂Ω through the equations

$$𝒟 [ u ( x ) ] = f ( x ) , \qquad x ∈ Ω ,$$

$$ℬ [ u ( x ) ] = g ( x ) , \qquad x ∈ \partial Ω$$

where [symbol] is a differential operator, [symbol] is a boundary operator, ƒ:Ω→ [symbol] ⁿ is a forcing function, and g:Ω→ [symbol] ⁿ is a boundary function. Physics-informed neural networks (PINNs) are a method to train the neural network u_{θ}: [symbol] ^{m}→ [symbol] ⁿ to approximate the solution u to this PDE without requiring training data samples of u. This is achieved by minimizing the physics-informed loss

$${L}_{physics} ( θ ) = \frac{1}{{N}_{r}} {\sum }_{i = 1}^{{N}_{r}} {( 𝒟 [ {u}_{θ} ( {x}_{i}^{r} ) ] - f ( {x}_{i}^{r} ) )}^{2} + \frac{1}{{N}_{b}} {\sum }_{i = 1}^{{N}_{b}} {( ℬ [ {u}_{θ} ( {x}_{i}^{b} ) ] - g ( {x}_{i}^{b} ) )}^{2}$$

where

$${x}_{i}^{r}$$

for i=1, . . . , Nᵣ are input points distributed inside the domain Ω, and

$${x}_{i}^{b}$$

for i=1, . . . , N_{b} are input points distributed on the domain boundary ∂Ω.

PINNs seek to train the neural network u_{θ} by embedding the PDE into the learning process, but they encounter significant challenges in learning the true solution u to the PDE. Indeed, the true solution u often displays heterogenous and multiscale behavior, meaning that the statistical relationship between the input x and the output u can vary significantly when the inputs x are far apart. This is particularly true when the system dynamics are highly nonlinear or chaotic, making the convergence of PINNs difficult and limiting their ability to model complex real-world interactions.

For example, consider the problem of learning the flow field around an airfoil, which is governed by the Navier-Stokes PDEs and characterized by a map from spatial coordinates x to velocity vector u. The relationship between spatial coordinates and velocity varies significantly depending on spatial location. Turbulence is created in the boundary layer adjacent to the airfoil's surface because of the surface's roughness and other effects, whereas far away from the airfoil, the flow tends to be more stable and laminar. A single global neural network trained using the PINNs methodology will struggle to accurately capture the inherent differences in airflow behavior close to or far away from the airfoil, leading to prediction errors. For example, the model may underpredict velocity fluctuations near the airfoil while overpredicting fluctuations away from it. This issue arises because a conventional neural network does not inherently differentiate between regions with distinct statistical properties, instead capturing the input-output relationship into a single global function, which fails to reflect the true behavior of systems displaying distinct regimes.

Thus, neural networks struggle to learn the behavior of systems exhibiting multiple distinct regimes, whether they are trained using data or physics-based constraints. Overcoming these limitations requires different approaches to enhance adaptability and accuracy.

One way to address this issue is by partitioning the input space into smaller regions and learning separate models for each. For example, when learning the dynamics of the flow field around an airfoil, the input space can be divided into spatio-temporal regions, where the behavior in each region is learned independently. This allows the model to account for localized variations in flow patterns. While effective in some cases, this approach is inconvenient because it requires manually defining partitions, which may not always align with the natural structure of the data. Additionally, the model must be retrained or reconfigured if the statistical properties of the input space change, limiting its adaptability. Finally, this approach requires modifying the training loss to allow for communication between different regions during training, which is necessary in the presence of physics-based constraints such as in PINNs.

A more flexible approach is to introduce window functions that automatically partition the input space during the training process. Instead of manually defining regions, the model uses these functions to adaptively assign different portions of the input space to different parts of the network, effectively creating a soft partitioning scheme. An exemplar formulation of such a partitioning is

$${u}_{θ} ( x ) = {\sum }_{j = 1}^{{N}_{part}} {φ}_{{ω}_{j}} ( x ) {u}_{{θ}_{j}} ( x )$$

where φ_{ω}_{ⱼ}: [symbol] ^{m}→ [symbol] is a learnable window function which defines a partition of the input space; u_{θ}_{ⱼ}: [symbol] ^{m}→ [symbol] ⁿ is a local neural network for learning the solution in that partition; and the trainable parameters are θ={ωⱼ,θⱼ:1≤j≤Nₚₐᵣₜ} Each window function is defined in such a way that it is zero everywhere except in a finite partition of the input space, so that the corresponding local neural network is activated only in that partition.

However, in this method, the number of window functions must still be predefined before training begins. This is problematic because the number of statistically distinct regions is often unknown in advance and can vary depending on the application.

In addition, during training, some window functions may collapse to zero, meaning that certain partitions effectively disappear. This occurs because the model, in its attempt to optimize performance, may deactivate some regions if they appear less relevant or if there is insufficient training data to justify their activation. As a result, portions of the input space may be entirely ignored, leading to a loss of expressivity and suboptimal performance.

Moreover, partitioning the input space into a predetermined number of regions often fails to account for dynamic variations inherent in time-dependent systems. A fundamental property of learning-based models is that they extract statistical relationships between input and output during training, assuming that these relationships remain stable between the training and execution stages. However, when the input space is partitioned once during the initial training process, even if the partitions are adaptively adjusted, the variations in statistical properties between training and real-world execution may not always align. In other words, the statistical stability required for effective learning does not always hold when the partitioning strategy is rigid or predetermined, leading to errors when the model is deployed on real-world data that exhibits unexpected or evolving temporal variations.

This highlights the need for a method that can dynamically determine both the number and extent of partitions in a way that adapts to the structure of the data without requiring manual intervention.

The present disclosure relates to machine learning architectures for supervised learning tasks and physical system modeling. More specifically, the disclosure introduces a hybrid neural network framework with adaptive architecture suitable to improve accuracy, computational efficiency, and generalization when handling data that is statistically heterogenous, in the sense that the statistical relationship between input and output can vary significantly when the inputs are far apart. The disclosure finds applications in areas where the process to be modeled can exhibit different regimes, such as airflow modeling, thermal management, and complex control systems.

Some embodiments recognize that when the input-output relationship to be learned exhibits multiple connected or correlated regimes in different regions of the input space, partitioning the input space into independent regions is not sufficient. For example, in airflow modeling, air movement in one part of a room directly influences adjacent areas, meaning that treating each region in isolation ignores these essential relationships. This interdependence means that partition-based models, where each region is learned separately, may fail to generalize properly. If one partition does not incorporate information from adjacent partitions, it may learn an incomplete or distorted statistical mapping that does not reflect the true behavior of the system.

Additionally, there may exist both short-range and long-range correlations in the input-output relationship to be learned. Instead of treating partitions as isolated units, some embodiments integrate global dependencies, allowing partitions to exchange information and ensuring that the model captures both localized variations and broader interactions, leading to a more accurate and adaptable representation of the data.

To address these challenges, the present disclosure introduces a novel hybrid neural network architecture that dynamically adapts to statistical heterogeneities of the data across the input space. Rather than relying on fixed or independent partitions, this architecture integrates both global and local learning mechanisms, ensuring that statistical relationships are captured at different scales.

Some embodiments disclose a neural network architecture that integrates both global and local learning to improve adaptability to statistical heterogeneities in the data. A global neural network captures large-scale statistical features, providing contextual information sharing across the entire input space and ensuring that broad patterns and dependencies are learned. Complementing this, multiple local neural networks specialize in distinct regions of the input domain, capturing fine-grained variations that may differ across different areas. By combining these components, the model can adapt to localized statistical properties while still benefiting from the shared global context, resulting in a more accurate and flexible mapping between input and output data.

The proposed architecture is represented as:

$${u}_{θ} ( x ) = {{u}_{θ}}_{global} ( x ) + {\sum }_{j = 1}^{{N}_{part}} {φ}_{{ω}_{j}} ( x ) {u}_{{θ}_{j}} ( x )$$

where: u_{θ}_{_{global}}: [symbol] ^{m}→ [symbol] ⁿ is a global neural network that captures large-scale statistical features; φ_{ω}_{ⱼ}: [symbol] ^{m}→ [symbol] is a learnable window function which defines a partition of the input space; and u_{θ}_{ⱼ}: [symbol] ^{m}→ [symbol] ⁿ is a local neural network for learning the solution in that partition. In this architecture, the trainable parameters are θ=θ_{global}↑{ωⱼ,θⱼ:1≤j≤Nₚₐᵣₜ}. Each window function is defined in such a way that it is zero everywhere except in a finite partition of the input space, so that the corresponding local neural network is activated only in that partition.

Notably, the global and local neural networks may have different architectures, optimized for deep learning, but their outputs are directly combined into the final output of the proposed architecture. This contrasts with approaches that merge features from multiple network components before producing a final prediction.

In this architecture, while the global neural network captures the average statistical relationship between input and output, the local neural networks learn localized deviations from this global mapping in different regions of the input space. This is fundamentally different from traditional partitioning methods, which attempt to learn only local variations of the data without leveraging a global model. Empirical evidence suggests that the local deviations from the global network's output exhibit more stable statistical relationships, particularly when learning functions of physical space.

For example, consider an airflow modeling scenario where the airflow velocity and temperature in a room with an open window is learned. An isolated partition-based model that only relies on local learning would struggle to learn the long-range effect of wind blowing through the window into a faraway corner of the room. However, with the proposed hybrid architecture, both the global and local neural networks work together to learn both close-range and long-range interactions effectively. The global neural network, which captures the overall airflow dynamics, learns the global flow pattern induced in the room by the wind blowing through the window, while the local neural networks refine the global prediction by learning localized deviations such as velocity fluctuations induced by localized turbulence phenomena near furniture. Since the local variations are learned relative to the global statistical trend, rather than in isolation, the model preserves consistency across different regions and prevents abrupt or incorrect adjustments.

Furthermore, the proposed architecture allows for faster and more accurate fine-tuning of solutions when the behavior of the system changes between the initial training and the inference phase, thanks to the adaptability of the local networks and their ability to account for both close range and long range interactions through the global network. This highlights the advantage of incorporating global context into local learning, allowing the model to generalize more effectively to unseen conditions.

One embodiment uses a single loss function applied only to the final output of the hybrid neural network. This approach ensures end-to-end optimization, where the global and local neural networks work together to minimize the overall prediction error rather than being trained independently. By focusing on the final output, the system naturally balances the contributions of the global and local networks, allowing the global network to capture general trends while the local networks refine region-specific variations only when necessary. This prevents unnecessary constraints on intermediate representations and ensures that each component of the hybrid model contributes optimally to the final prediction.

This single-loss function strategy also fosters a coherent and consistent output representation, seamlessly integrating the contributions of both the global and local models. The trainable window functions governing local network activation adjust dynamically, ensuring that only the necessary local models are engaged, preventing redundancy. This adaptability makes the hybrid neural network highly scalable, capable of handling statistically heterogeneous data effectively while maintaining computational efficiency. Ultimately, training the hybrid model with a loss function focused solely on the final output leads to a more robust, efficient, and scalable AI system that can dynamically allocate computational resources based on the input data.

Some embodiments are based on recognizing that reducing the number of local neural networks while ensuring that the combination of window functions covers only a portion of the input space significantly enhances computational efficiency and model adaptability. By limiting local network activation to regions where fine-grained refinements are necessary, the system avoids unnecessary complexity and ensures that computational resources are allocated efficiently. This selective activation strategy prevents local networks from redundantly learning in areas where the global neural network alone can provide sufficiently accurate predictions, thereby reducing training time, inference costs, and memory usage.

In some embodiments, a compound loss function is used to minimize the number of local neural networks by separately penalizing errors in the global neural network's output and the combined output of the hybrid neural network. The first component of the loss function ensures that the global neural network captures the dominant trends in the data, reducing reliance on local networks. The second component penalizes errors in the final hybrid output, which integrates contributions from both the global and local neural networks. This design encourages local networks to activate only when they provide a significant reduction in overall prediction error.

To further optimize computational efficiency, a regularization term can be incorporated into the loss function to penalize activation of an excessive number of local neural networks for any given input data. This term discourages unnecessary complexity by ensuring that local networks are only engaged when absolutely required, preventing redundancy and reducing computational overhead. Below are several effective regularization techniques.

In some embodiments an L1 penalty can be applied to the outputs of the local window functions to encourage sparsity:

$$λ {\sum }_{i} \vert {φ}_{{ω}_{i}} \vert$$

This discourages unnecessary activation of local networks unless they significantly reduce prediction error. (λ is a weight parameter applied to the regularization term.)

In some embodiments an L0 penalty is introduced to limit the number of active local networks:

$$λ {\sum }_{i} 1 ( {φ}_{{ω}_{i}} > 0 )$$

In some embodiments a penalty is applied based on the fraction of total output contributed by the local networks:

$${λ ( \frac{{\sum }_{i} {φ}_{{ω}_{j}} {u}_{{θ}_{j}}}{{u}_{{θ}_{global}} + {\sum }_{i} {φ}_{{ω}_{j}} {u}_{{θ}_{j}}} )}^{2}$$

This ensures that local networks contribute minimally unless their activation significantly improves model performance.

By incorporating one or more of these regularization techniques, the hybrid neural network dynamically optimizes the number of active local neural networks, ensuring computational efficiency, scalability, and accurate prediction.

Various embodiments of a hybrid neural network with adaptive architecture leverage the hybrid structure and principles of hybrid neural networks to dynamically adapt their architecture based on training data and/or the nature of the task. Traditionally, neural network adaptability is achieved by selecting a fixed architecture and optimizing its parameters during training. However, the principles employed in embodiments disclosed herein enable not only parameter optimization but also structural modifications, allowing the network architecture itself to evolve in response to changing conditions.

A hybrid neural network with an adaptive architecture is designed to modify its structure dynamically by adjusting the total number of local networks based on the characteristics of the training data and task requirements. Unlike conventional neural networks with a predefined architecture, this approach supports real-time adjustments, optimizing both computational efficiency and predictive accuracy.

This adaptability is achieved through the hybrid network structure, which integrates a global neural network to capture broad trends across the input space and a set of local neural networks to specialize in learning finer variations. In addition to the local adaptivity enabled by the trainable window functions, which automatically adjust the activation regions of local neural networks, the system also dynamically adjusts the total number of local networks depending on when additional learning capacity is required. By selectively allocating computational resources to regions of high complexity, the network avoids redundant processing and enhances efficiency.

Additionally, some embodiments implement meta-learning strategies or reinforcement learning-based controllers to continuously monitor incoming data and modify the hybrid network's architecture accordingly. This self-optimization process improves performance in tasks where data distributions evolve over time. By combining structural flexibility with hybrid learning principles, the adaptive neural network effectively balances generalization and specialization, making it highly suitable for complex time-dependent and statistically heterogeneous problems.

Moreover, this adaptability extends to Physics-Informed Neural Networks (PINNs), enabling various embodiments to address complex dynamical systems. In addition to local adaptivity enabled by the trainable window functions, some implementations introduce structural adaptivity by allowing the number of local networks to change dynamically during training. This structural adaptivity ensures that the network allocates varying levels of expressivity across different subsets of the input domain based on the local behavior of the solution, optimizing performance throughout training.

Some implementations propose a residual-based criterion for adding or removing local networks according to the local value of the mean-squared error residual, (u_{θ}(xᵢ)−yᵢ)² (for supervised learning) or

$${( 𝒟 [ {u}_{θ} ( {x}_{i}^{r} ) ] - f ( {x}_{i}^{r} ) )}^{2}$$

(for PDE learning in PINN).

At regular intervals during training, the system adds local networks and corresponding window functions where the residual error exceeds a predefined threshold, indicating a need for increased model capacity. Conversely, it removes local networks and corresponding window functions where the residual error falls below another threshold, signifying that fewer local models are necessary. These operations—adding and removing local networks—are independent, allowing for flexible control over network complexity. Depending on the implementation, the system may perform either operation independently or both simultaneously.

By dynamically adjusting both local activations regions and overall architecture, these embodiments ensure efficient learning, optimized computational resource allocation, and improved predictive accuracy, making them highly effective for complex, data-driven, and physics-informed modeling applications.

In some embodiments, the architecture of the hybrid neural network is configured to enhance the adaptability and efficiency of pretrained models by introducing local adaptive networks that dynamically correct localized deficiencies. Unlike fine-tuning methods that modify the entire network globally, certain embodiments recognize that errors in a pretrained model are often localized to specific regions of the input space. These embodiments are based on recognizing that pretrained models serve as global representations of a task, but their performance may degrade in certain subdomains, such as specific data distributions, environmental conditions, or domain-specific nuances.

Some embodiments leverage a hybrid architecture consisting of a static global model (the pretrained network) and a set of dynamically generated local networks. In such embodiments, the local networks act as adaptive correction units, selectively enhancing the performance of the pretrained model in regions where it struggles. This approach addresses a fundamental inefficiency in traditional fine-tuning: instead of modifying the pretrained model indiscriminately, local models are selectively added, adjusted, or removed based on real-time performance analysis.

For example, certain embodiments apply this adaptive tuning framework to large language models (LLMs), vision transformers, and other deep learning architectures. In these embodiments, fine-tuning large models is often computationally prohibitive due to the sheer number of parameters. Some embodiments reduce the computational cost of adaptation by selectively tuning only the regions of the model that require refinement, leaving well-generalized portions intact. This approach enables efficient adaptation to new languages, domains, or specialized tasks without requiring full retraining.

In some embodiments, the system is configured to operate in real-time environments, where models must adapt dynamically to incoming data. For instance, in autonomous navigation, a self-driving car may encounter unexpected environmental conditions (e.g., heavy fog or new road patterns). Instead of retraining the entire perception model, some embodiments introduce local adaptation modules that refine perception under specific conditions on the fly. Similarly, in medical imaging, a pretrained diagnostic model may be enhanced using local adaptation layers that specialize in detecting rare diseases or handling variations in imaging modalities.

Additionally or alternatively, in some embodiments, the local adaptation mechanism is modular and composable, allowing different types of local networks to be integrated seamlessly. Some embodiments support domain-specific adaptation, where different local networks are trained for different tasks but share a common global model. This allows for multi-task learning and cross-domain adaptation, where a single base model can be enhanced in multiple ways depending on the application.

In effect, some embodiments provide a novel framework for fine-tuning pretrained neural networks using locally adaptive corrections. By recognizing that pretrained models serve as global baselines with localized deficiencies, these embodiments introduce a self-organizing architecture that dynamically deploys local networks only where needed. This approach preserves global knowledge while improving model performance in specific regions of the input space, offering a scalable, efficient, and flexible alternative to traditional fine-tuning techniques.

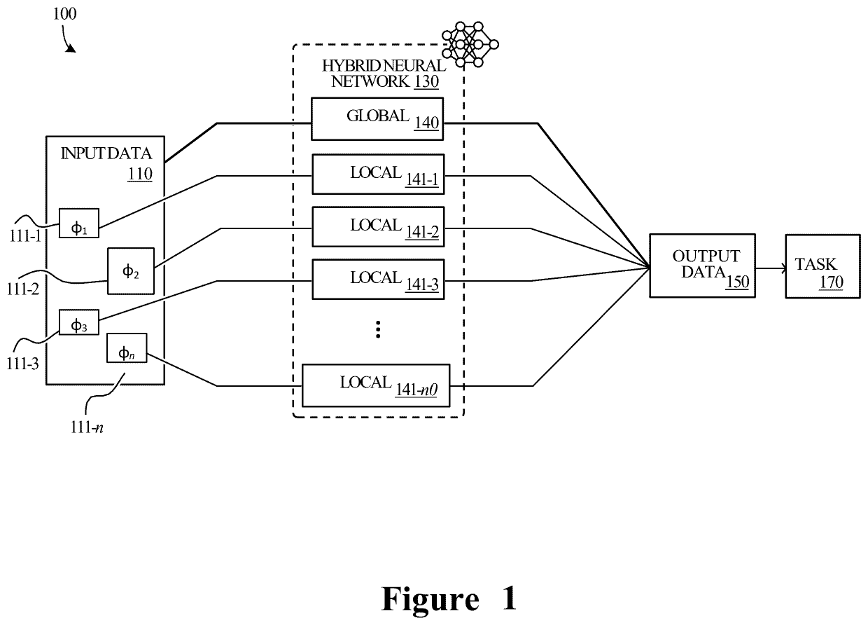

Turning now to the Figures, FIG. 1 illustrates operational environment 100 for the performance of a task including processing input data by an adaptive hybrid neural network and mapping it to output data in an implementation. Operational environment 100 includes input data 110, hybrid neural network 130, output data 150, and task 170. Input data 110 includes partitions 111-1, 111-2, 111-3, . . . , 111-n, collectively, “partitions 111.” Hybrid neural network 130 includes global neural network 140, and local neural networks 141-1, 141-2, 141-3, . . . , 141-n, collectively, “local networks 141.”

Input data 110 contains an ensemble of individual data points representative of data received and processed by a neural network architecture to generate output data. Input data 110 may include sensor measurements, structured datasets, time-series data, image or video frames, spatial and temporal coordinates, textual information, or any combination thereof, depending on the specific application. Input data 110 may be pre-processed to enhance signal quality, normalize values, remove noise, or extract relevant features before being fed into the neural network. Preprocessing may involve techniques such as data scaling, outlier detection, feature selection, dimensionality reduction, and transformation into a standardized format to improve model performance and stability. For instance, numerical data may be normalized or standardized to ensure consistent input distributions, while categorical data may be encoded into numerical representations suitable for network processing. Prior to processing by a neural network, the preprocessed data may undergo augmentation or enrichment, such as synthetic data generation, Fourier features embedding, interpolation for missing values, or noise filtering to improve robustness. Input data 110 may be partitioned by the application of window functions based on temporal, spatial, frequency, contextual, or other characteristics and selectively routed to global and local network components of a hybrid neural network for processing.

Partitions 111 are representative of one or more partitions of input data 110 based on characteristics (temporal, spatial, frequency, etc.) relevant to the processing task. Partitions 111 may be determined based on window functions φᵢ. In an implementation, for a given partition of partitions 111, window function φᵢ partitions input data 110 by applying a zero weighting to values of input data 110 outside the partition so that a corresponding local neural network processes only values within the partition. For example, window function φ₂ forms partition 111-2 by zeroing out values outside of partition 111-2 so that local network 141-2 processes only values within partition 111-2. In various implementations, the combination of window functions or partitions 111 covers only a portion of input data 110. Stated another way, some portions of input data 110 are processed only by global network 140. Similarly, some portions of input data 110 may be processed by global network 140 and one or more of local networks 141.

In various implementations, partitions 111 define discrete segments of data that can be independently analyzed while preserving meaningful relationships within the dataset. The configurations of partitions 111 may be application-dependent and can include temporal, spatial, frequency-based, contextual, or other types of partitioning. In temporal partitioning, window functions may segment time-series data into fixed or adaptive intervals, enabling the neural network to capture short-term patterns, trends, and cyclic behaviors within a dynamic system. Spatial partitioning (including geospatial partitioning) may apply window functions to divide data based on positional or geometric relationships. Frequency-based windowing may be used in applications where data is analyzed in the spectral domain. Contextual partitioning defines windows based on domain-specific attributes or logical groupings within the input data. For instance, in a multi-sensor fusion system, window functions may segment data streams based on sensor type, location, or operational conditions to ensure that independent sources of information are processed in a structured manner. Similarly, in natural language processing, text may be partitioned into semantic units, such as sentences or paragraphs, to enhance coherence in downstream analysis.

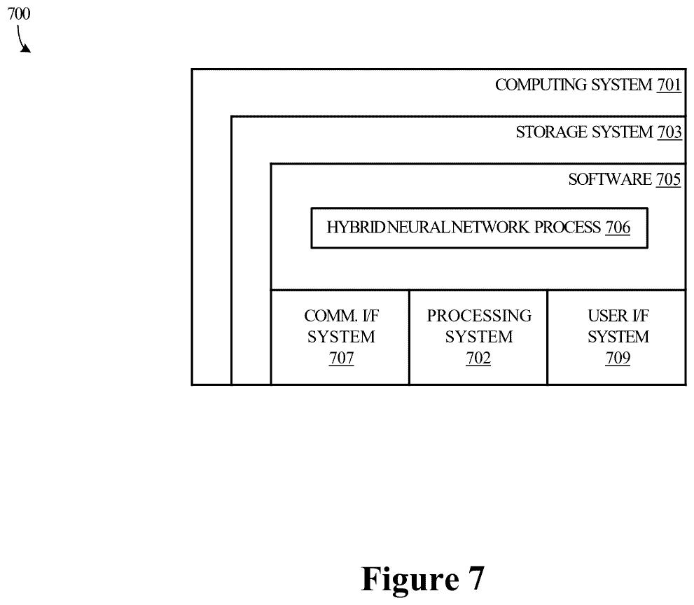

Hybrid neural network (HNN) 130 is representative of an adaptive hybrid neural network architecture including global network 140 and one or more of local networks 141. Hybrid neural network 130 may be implemented in computing software on a suitable computing device or devices, e.g., computing device 701 of FIG. 7. Hybrid neural network 130 processes input data 110 and partitions 111 of input data 110 simultaneously or in parallel, producing output data 150. For example, global network 140 processes input data 110 while local networks 141 positioned along the processing path process portions of input data 110.

Global neural network 140 of hybrid neural network 130 is representative of a neural network architecture comprising multiple interconnected layers of artificial neurons configured to process input data and generate output predictions. Global network 140 may include an input layer for receiving data, one or more hidden layers for feature extraction and transformation, and an output layer for producing results based on learned representations. Each layer of global network 140 may utilize various activation functions, weight parameters, and bias parameters to optimize performance. Global network 140 may be implemented using a fully connected, convolutional, recurrent, transformer-based, or hybrid topology, depending on the application.

Local neural networks 141 of hybrid neural network 130 are representative of one or more neural network architectures comprising multiple interconnected layers of artificial neurons configured to process input data and generate output predictions. Each of local networks 141 may include an input layer for receiving data, one or more hidden layers for feature extraction and transformation, and an output layer for producing results based on learned representations. Each layer of local networks 141 may utilize various activation functions, weight parameters, and bias parameters to optimize performance. Local networks 141 may be implemented using a fully connected, convolutional, recurrent, transformer-based, or hybrid topology, depending on the application. In some implementations, the respective architectures of local networks 141 can vary. For example, a first local network may include a recurrent neural network (RNN) architecture, while a second local network may include a convolutional neural network (CNN) architecture.

Output data 150 is representative of processed information generated by a trained neural network architecture in response to input data. In an implementation, output data 150 includes output generated by multiple neural networks of a hybrid neural network system, such as output from a global network processing input data and output from one or more local neural networks processing partitions of the input data; the combined output of the global and local networks provide an adaptive representation of statistical relationships between input data 110 and output data 150. Types of data included in output data 150 can include classification labels, regression values, probability scores, feature embeddings, decision boundaries, predicted sequences, or other inference results based on the network's learned parameters. The format and structure of output data 150 can include scalar values, multi-dimensional arrays, confidence distributions, structured data representations, control signals, or the like. Output data 150 may also include auxiliary information such as attention weights, uncertainty or confidence estimates, intermediate activations, etc., which may be used for interpretability, further processing, or integration with downstream systems.

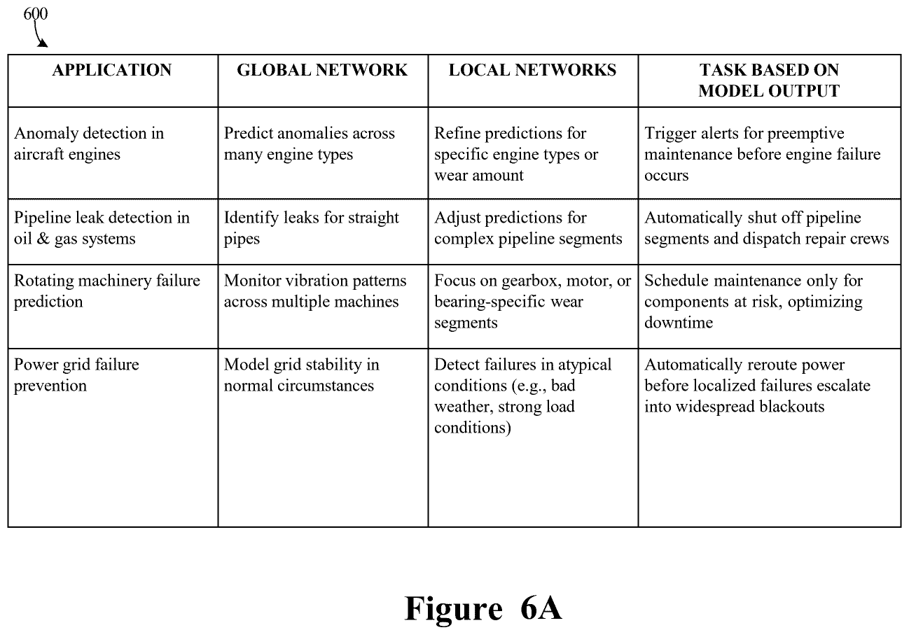

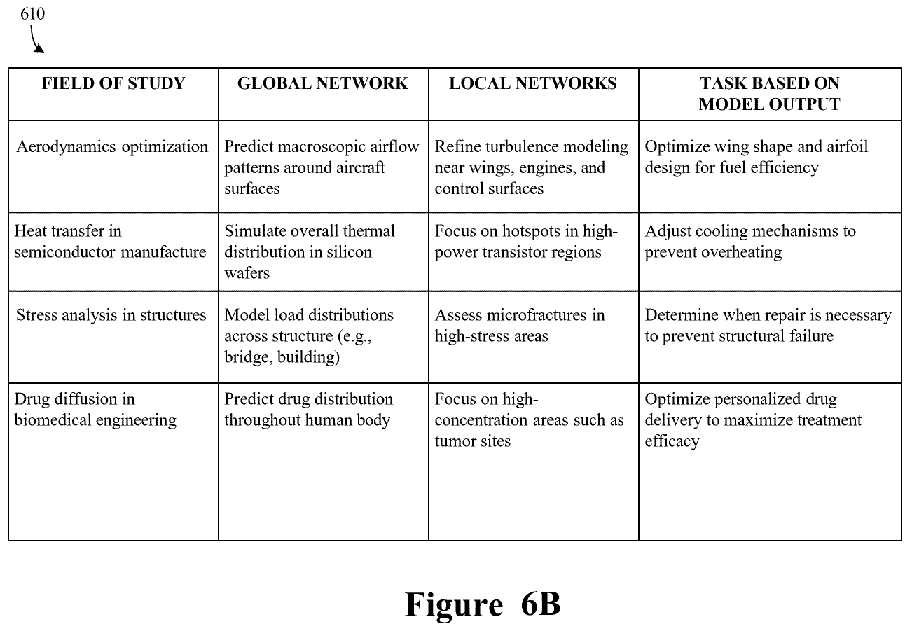

Task 170 is representative of an action taken in response to output data 150 generated by processing of input data 110 by hybrid neural network 130. Examples of actions taken in response to input data are illustrated in FIGS. 6A and 6B, discussed infra.

A brief operational scenario of operational environment 100 follows. In an implementation, hybrid neural network 130 is trained to infer a solution, embodied in output data 150, based on input data 110. To generate output data 150, global network 140 receives and processes input data 110 and generates output based on the entirety of input data 110. Similarly, each of local networks 141 receives and processes a partition (of partitions 111) of input data 110 based on a corresponding window function. The combined output of global network 140 and local networks 141 is used to determine or perform a task responsive to the information embodied in input data 110.

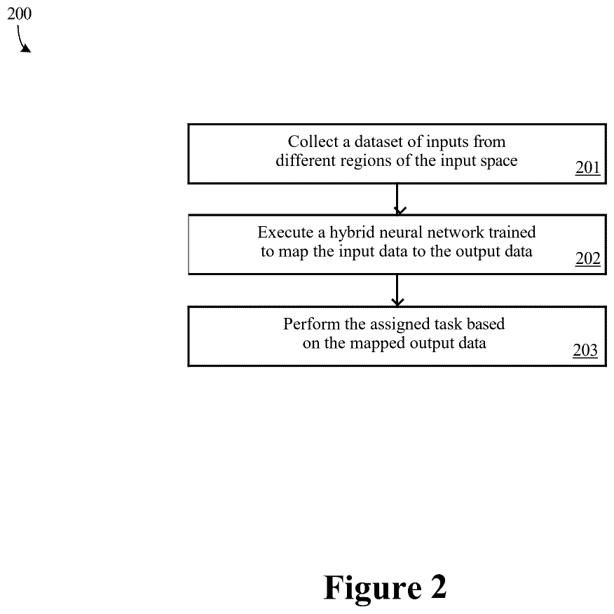

FIG. 2 illustrates a method for performing a task by processing input data from an input space and mapping it to output data in an output space by means of a feedback artificial intelligence (AI) system in an implementation, herein referred to as process 200. Process 200 may be implemented in program instructions in the context of any of the software applications, modules, components, or other such elements of one or more computing devices. The program instructions direct the computing device(s) to operate as follows, referred to in the singular for the sake of clarity.

A computing device collects a dataset of inputs from different regions of the input space (step 201). In an implementation, the computing device receives data from different regions of an input space of a complex environment. The complex environment can include or exhibit global behavior, characteristics, or phenomena along with one or more distinct regimes exhibiting localized behavior, characteristics, or phenomena. The inputs may be preprocessed and configured as a multi-dimensional array for processing by a hybrid neural network.

The computing device executes a hybrid neural network trained to map the input data to the output data (step 202). In various implementations, the hybrid neural network includes a global neural network and a plurality of local neural networks. The global network may be trained to process the input data from any region of the input space to generate corresponding output data. The plurality of local networks may be positioned along a processing path of the input data, with each network associated with a distinct partition of the input space defined by a trainable window function. Each local network of the plurality of local networks processes input data only if it falls within its designated partition determined by the corresponding window function. Additionally, the respective architectures of the local networks may vary with each configured and optimized for its particular partition of input data.

During processing, the global and local networks of the hybrid neural network process the input data by mapping the input data to output (i.e., values in the output space) in accordance with their training. By processing the entirety of the input data, the global network can capture large-scale statistical relations (e.g., global patterns or large-scale behavior) embodied in the input data. Each of the local networks processes a designated portion of the input data to capture localized patterns or smaller-scale behavior in the input data. The output of the hybrid neural network generates output data that integrates outputs from both the global neural network and the local neural networks.

The computing device performs the assigned task based on the mapped output data (step 203). In an implementation, the computing device performs the assigned tasks based on the integrated output of the hybrid neural network, wherein the integrated output is informed by global relationships as well as local or regime-specific relationships. Such tasks can include anomaly detection, design optimization, fine-tuning an action or response, and the like.

Returning to FIG. 1, a brief example of process 200 as employed by elements of operational environment 100 follows. In an exemplary implementation, a computing system executing software for modeling and controlling airflow to perform a task captures input data 110 collected from different regions of an input space. For example, to model the airflow in an enclosed environment, the input space may include static temperature and airflow velocity measurements captured by sensors at various times and at various spatial locations in the environment. The sensors may capture global trends in the airflow dynamics but also distinctive dynamics of particular regions in the environment. Input values associated with a particular region may be defined by a window function φᵢ which when applied to input data 110 isolates those values associated with the region.

The computing system executes hybrid neural network 130 trained to map the input data 110 to output data in order to perform task 170 with respect to the environment. In an implementation, hybrid neural network 130 includes global network 140 and a plurality of local networks 141. Global network 140 is trained to model global trends in the airflow dynamics of the environment; each of local networks 141 is trained to model particular regions with distinctive flow patterns in the environment. Global network 140 receives and processes input data 110, while each of local networks 141 receives a designated portion or partition (of partitions 111-114) of input data 110, as determined by a corresponding window function di.

Hybrid neural network 130 processes input data 110, with each of global network 140 and local networks 141 processing input data 110 or designated portions of input data 110 and returning output data 150. Output data 150 of hybrid neural network 130 comprises the outputs generated by the various networks of hybrid neural network 130.

The computing system performs task 170 based on output data 150. Because output data 150 embodies an awareness of global as well as local or regime-specific trends, the task will be particularized to input data 110. In various implementations, if conditions in the environment change, different configurations of hybrid neural network 130 may be used to generate output data 150 for performing task 170. For example, if a particular region with a distinctive flow pattern is no longer present in the environment, the corresponding local network may be removed from the processing path. Alternatively, if a new region of distinctive flow is added to the environment, a local neural network (which has been trained on training data for the new region) may be introduced into the processing path.

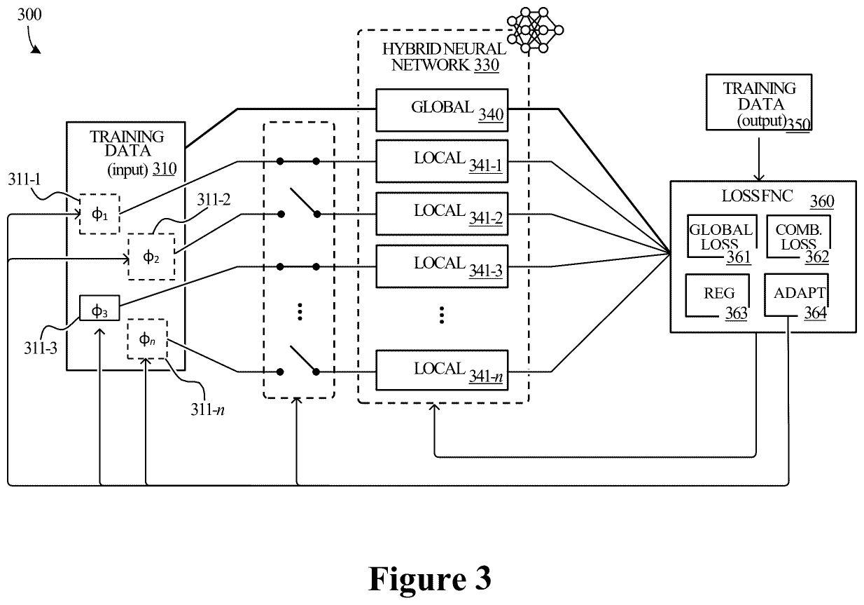

FIG. 3 depicts operational environment 300 for training an adaptive hybrid neural network for the performance of a task in an implementation. Operational environment 300 includes input training data 310, hybrid neural network 330, output training data 350, and loss function 360. Input training data 310 includes partitions 311-1, 311-2, 311-3, . . . , 311-n, collectively, “partitions 311.” Hybrid neural network 330 includes global neural network 340 and local neural networks 341-1, 341-2, 341-3, . . . , 341-n, collectively, “local networks 341.” Loss function 360 includes global loss component 361, combined loss component 362, regularization component 363, and adaptive component 364.

Input data 310 is representative of data received and processed by hybrid neural network 330 to generate predicted output values. Input data 310 may be apportioned by window functions φᵢ into one or more partitions (represented by partitions 311) which are selectively routed to global and local network components of hybrid neural network 330 for processing. Input data 310 can include data of the same type, structure, format, or sources of data to be processed by hybrid neural network 330 at run-time, such as input data 110 of FIG. 1.

Partitions 311 are representative of one or more portions of input data 310 corresponding to activation regions of corresponding ones of local networks 341. In an implementation, each of partitions 311 is determined based on a corresponding window function φᵢ. In an implementation, for a given partition of partitions 311, window function φᵢ partitions input training data 310 by applying a zero weighting to values of input data 310 outside the partition so that a corresponding local neural network processes only values within the partition. During training, the window function φᵢ of a given partition may dynamically adjust the partition to adjust the activation region of the corresponding local network in response to feedback received from loss function 360. For example, in response to feedback from loss function 360 for given local network, the window function φᵢ corresponding to the given local network may increase or decrease the set of data values of input data 310 which are included in the partition for that network.

Hybrid neural network 330 is representative of an adaptive hybrid neural network architecture including global network 340 and one or more of local networks 341. Hybrid neural network 330 may be implemented in computing software on a suitable computing device or devices, e.g., computing device 701 of FIG. 7. Hybrid neural network 330 processes input data 310 and partitions 311 of input data 310 to produce output data which is processed by loss function 360. For example, global network 340 processes input data 310 while local networks 341, positioned along the processing path, process partitions 311, respectively, of input data 310.

Global neural network 340 is representative of a neural network architecture comprising multiple interconnected layers of artificial neurons configured to process input data and generate output predictions. Global network 340 may include an input layer for receiving data, one or more hidden layers for feature extraction and transformation, and an output layer for producing results based on learned representations. Each layer of global network 340 may use various activation functions, weight parameters, and bias parameters. The parameters of global network 340 are optimized during training to model processes or relationships embodied input and output training data. Global network 340 may be implemented using a fully connected, convolutional, recurrent, transformer-based, or hybrid topology, depending on the application. The architecture of global network 340 may employ optimization techniques including backpropagation, gradient descent, or evolutionary algorithms to refine model accuracy over time.

Local neural networks 341 of hybrid neural network 330 are representative of one or more neural network architectures comprising multiple interconnected layers of artificial neurons configured to process input data and generate output predictions. Each of local networks 341 may include an input layer for receiving data, one or more hidden layers for feature extraction and transformation, and an output layer for producing results based on learned representations. Each layer of local networks 341 may utilize various activation functions, weight parameters, and bias parameters to optimize performance. Local networks 341 may be implemented using a fully connected, convolutional, recurrent, transformer-based, or hybrid topology, depending on the application. In some implementations, the type of neural network architecture may vary among local networks 341. For example, a first local network may include a recurrent neural network (RNN) architecture, while a second local network may include a convolutional neural network (CNN) architecture. The respective architectures of local networks 341 may employ optimization techniques including backpropagation, gradient descent, or evolutionary algorithms to refine model accuracy over time.

Loss function 360 is representative of one or more functionalities for quantifying the difference or error between predicted outputs generated by the networks of hybrid neural network 330 and output training data 350 during training. Loss function 360 may be implemented in computing software in conjunction with hybrid neural network 330 on a suitable computing device or devices, e.g., computing device 701 of FIG. 7. As an error analysis module for hybrid neural network 330, loss function 360 serves as an optimization objective, guiding the adjustment of network parameters of global network 340 and local networks 341 to minimize error and improve model performance. In an implementation, the error computed by loss function 360 is a compound loss which is computed based on errors returned by global loss component 361 and combined loss component 362. In various implementations, loss function 360 includes one or more regularization terms (e.g., L1 or L0 penalties) of regularization component 363. In various implementations, loss function 360 includes adaptive component 364 for activating and deactivating various ones of local networks 341 during training. In various implementations, loss function 360 includes a fusion module configured to integrate predictions from global network 340 and active local networks 341 such that each local network's contribution is weighted according to its corresponding, dynamically trained window function defining the spatial and contextual relevance of that local network.

Global loss component 361 of loss function 360 is representative of a functionality for determining the loss (i.e., residual error between predicted outputs and output training data 350) for global network 340. By separately computing and penalizing errors associated with global network 340, global loss component 361 causes or encourages global network 340 and therefore hybrid neural network 330 to learn dominant trends or global statistical relationships in input training data 310. Global loss component 361 may include mean squared error (MSE), cross-entropy loss, Huber loss, Kullback-Leibler divergence, physics-informed loss, or other domain-specific metrics, or combination thereof. Global loss component 361 may be adapted dynamically, weighted, or regularized to enhance stability, robustness, and generalization of global network 340.

Combined loss component 362 is representative of a functionality for determining the loss or error between the predicted outputs of global networks 340 and activated ones of local networks 341 and respective output training data 350. By separately computing and penalizing errors associated with the combined contributions of global network 340 and activated ones of local networks 341, combined loss component 362 encourages local networks 341 to activate only when they provide a significant reduction in the overall prediction error. Combined loss component 362 may include mean squared error (MSE), cross-entropy loss, Huber loss, Kullback-Leibler divergence, physics-informed loss, or other domain-specific metrics, or combination thereof. Combined loss component 362 may be adapted dynamically, weighted, or regularized to enhance stability, robustness, and generalization of the networks of hybrid neural network 330.

Regularization component 363 is representative of one or more techniques to account for activations of local neural networks, for example, to penalize excessive activations to ensure optimal as well as efficient processing of the input data at inference. Regularization component 363 can include an L1 penalty based on the output of the window functions to encourage sparsity, i.e., sparse partitions. Regularization component 363 may also or alternatively include an L0 penalty based on the number of active local networks. Regularization component 363 may also or alternatively include a penalty based on the fraction of total output contributed by the local networks to ensure that the local networks contribute minimally unless their activation significantly improves the performance of hybrid neural network 330. By incorporating one or more such regularization techniques into the compound loss computed by loss function 360, hybrid neural network 330 dynamically optimizes the number of active local networks of local networks 341 for computational efficiency, scalability, and accurate prediction.

Adaptive component 364 is representative of a functionality for identifying networks of local networks 341 for activation or deactivation based on characteristics of the input data, the task to be performed based on the output data, physics-based constraints, or a combination thereof. In an implementation, adaptive component 364 computes a residual-based criterion (e.g., mean-squared error residual or physics-informed residual) for adding or removing (i.e., activating or deactivating) networks of local networks 341 with respect to hybrid neural network 330. For example, adaptive component 364 monitors residual errors generated by hybrid neural network 330 for various values of input training data 310. At regular intervals during training, when the residual error for an input value exceeds a predetermined threshold, adaptive component 364 adds or activates a local network and initializes its window function at the input value exceeding the threshold. Conversely, when the residual error for input values within a partition defined by the window function of a local network falls below a predetermined threshold, adaptive component 364 removes or deactivates the corresponding local network. (The predetermined thresholds for activation and deactivation may be different.)

Output training data 350 is representative of ground-truth values corresponding to input training data 310 which serve as reference outputs in supervised training of hybrid neural network 330. In an implementation, loss function 360 computes differences or errors between predicted output values of hybrid neural network 330 and corresponding values of output training data 350; the errors are used to adjust the parameters of the hybrid neural network 330 to improve its predictive capability.

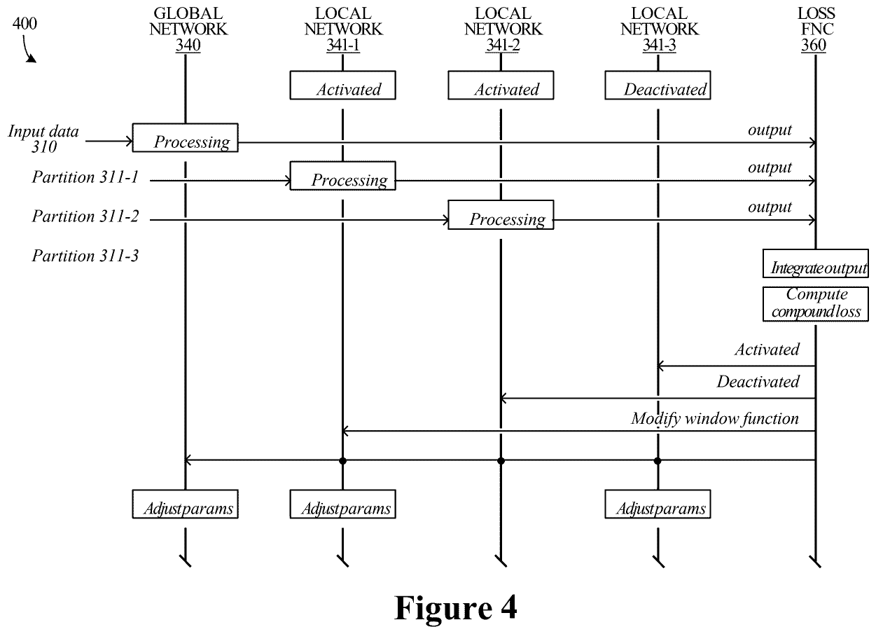

FIG. 4 illustrates exemplary workflow 400 for training an adaptive hybrid neural network for mapping data from an input space to an output space in an implementation referring to elements of FIG. 3. (For ease of illustration, it is assumed that hybrid neural network 330 includes three local networks.) At the start of a training cycle, two of the three local networks of hybrid neural network 330 are activated. Global network 340 receives and processes input training data 310, while local networks 341-1, 341-2, and 341-3 receive and process input data of corresponding partitions 311-1, 311-2, and 311-3 of input training data 310, defined by the corresponding window functions, when they are activated. Loss function 360 combines the outputs generated by global network 340 and each of the activated networks of hybrid neural network 330 to predict the corresponding output data, based upon which it computes a single, compound loss with respect to output training data 350 by which adjustments to the parameters of the models can be determined. In some scenarios, the compound loss includes one or more regularization terms or penalties which encourage efficient use of the local networks (e.g., sparsity, minimal number of local networks). The compound loss is also used as a feedback mechanism to adjust the parameters (e.g., weights, biases) of global network 340 and various ones or all of local networks 341-1, 341-2, and 341-3, as well as the locations and coverages of the corresponding window functions 311-1, 311-2, and 311-3.

In some implementations, loss function 360 computes a local value of the mean square error (MSE) of the output of hybrid neural network 330 corresponding to some or all values in the input data 310. Loss function 360 compares each of the local errors to activation and deactivation thresholds to determine whether the activation status of any of the local networks should change. As illustrated in workflow 400, the local MSE for some subset of the input data exceeds a threshold, which causes the (deactivated) local network 341-3 to be activated and its window function to be initialized in the center of that subset of the input data. Similarly, the local MSE for input data values within the partition defined by window function 311-2 of local network 341-2 has fallen below a threshold which causes that network to be deactivated. Finally, the local MSE for input data values within the partition defined by window function 311-1 of local network 341-1 is such that there is no change to its activation status, however, the activation region of local network 341-1 is modified by adjusting its corresponding window function. This type of modification to the activation region reflects the local adaptivity of hybrid neural network 330 enabled by the trainable window functions. In modifying the window function, corresponding partition 311-3 will include more or fewer data values for the next training cycle in accordance with the local MSE calculation, thereby modifying the spatial placement of partition 311-3 in the input space of input data 310. The parameters of the various networks which will be active in subsequent training or deployed for inference are also adjusted according to the local errors computed by loss function 360, for example, using gradient descent during backpropagation.

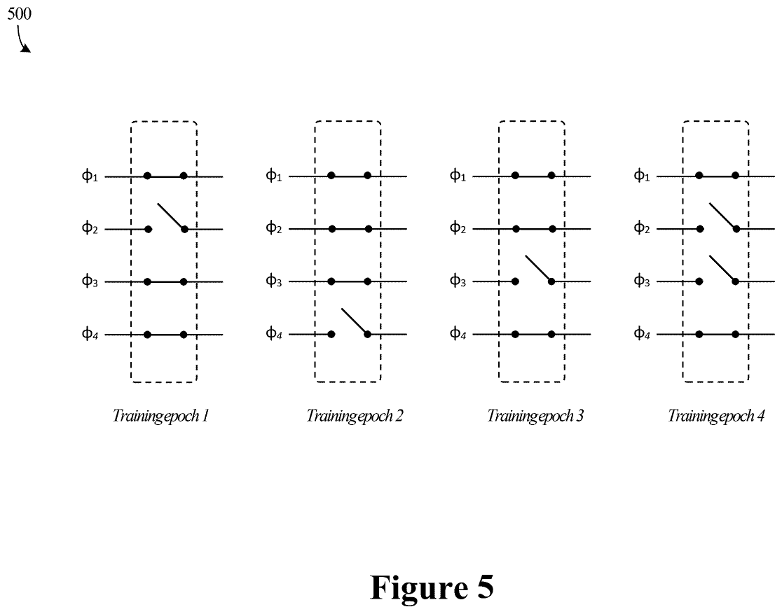

FIG. 5 depicts training scenario 500 of adaptive switching of local networks into and out of an adaptive hybrid neural network during training in an implementation. In training scenario 500, an adaptive hybrid neural network includes a global network (not shown) and four local neural networks with corresponding window functions φ₁, φ₂, φ₃, and φ₄; training using input training data 310 and output training data 350 commences with the four local networks activated in the hybrid network. At the conclusion of training epoch 1, a residual-based criterion, such as the mean-squared residual error, is computed for all values in the input training data 310. The residual error for input values within the partition defined by the window function of the second local network falls below a predetermined threshold (suggesting that the second local network is not having a significant effect on the overall performance of the hybrid network), and an adaptive component of the hybrid neural network deactivates the second local network. The residual errors for input values within the partitions defined by the window functions of the other local networks remain above the threshold; therefore, these local networks remain active. Training continues with the second local network deactivated. Throughout training scenario 500, the window functions of the local networks that are active may be modified (which changes the set of data values included in the corresponding partitions) based on an error metric for the corresponding network.

At the conclusion of training epoch 2, the residual error for input values within the partition defined by the window function of the second local network exceeds a second predetermined threshold (suggesting that the second local network is now required to improve the overall performance of the hybrid network) causing the adaptive component of the hybrid network to (re) activate the second local network for the next epoch of training. In addition, and independently of the performance of the other local networks, the residual error for input values within the partition defined by the window function of the fourth local network falls below the (first) predetermined threshold causing the fourth local network to be deactivated for the next epoch of training.

At the conclusion of training epoch 3, the residual errors for input values within the partitions defined by the window functions of the third and fourth local networks cause the corresponding networks to be deactivated and activated, respectively. At the conclusion of training epoch 4, the residual error for input values within the partition defined by the window function of the second local network causes it to be deactivated.

Continuing with operational scenario 500, for the sake of illustration, it will be assumed that training is concluded at the end of training epoch 4. At run-time, the hybrid neural network is deployed with the global neural network and the first and fourth local networks activated.

An adaptive hybrid neural network according to the technology disclosed herein can be used to provide actionable insights across multiple industries. FIGS. 6A and 6B summarize non-limiting examples of tasks which may be performed based on the output of a hybrid neural network with adaptive architecture in areas such as autonomous navigation, industrial predictive maintenance, and physics-driven simulations, ensuring optimal resource allocation and high-performance learning.

As illustrated by the examples in Table 600 of FIG. 6A, hybrid neural networks can be used to predict equipment failures by modeling both overall system behavior along with component-specific anomalies. This approach enhances predictive maintenance across various industries, allowing for early detection of potential failures and reducing operational disruptions. For instance, in aircraft engine monitoring, a global network of a hybrid neural network analyzes anomalies across multiple engine types, while the hybrid neural network's local networks refine predictions for specific models and levels of wear. This enables the hybrid neural network system to trigger alerts for preemptive maintenance before an engine failure occurs, improving safety and reliability.

In the oil and gas sector, a hybrid neural network system can be used to enhance pipeline leak detection. The global network of a hybrid neural network system may be trained to identify leaks in standard, straight pipe configurations, while the local networks of the hybrid neural network system can adjust for more complex structures such as curved pipes, expansion joints, and T-junctions. When a leak is detected, the hybrid neural network system can automatically shut off the affected pipeline segments and dispatch repair crews to mitigate damage.

Rotating machinery, such as industrial motors and gearboxes, can benefit from a similar hybrid approach. The global network continuously monitors vibration patterns across multiple machines, while local networks focus on wear patterns in specific components such as gearboxes, motors, or bearings. By identifying only the components at risk, the system optimizes maintenance schedules, reducing unnecessary downtime and repair costs.

Power grid stability is an application where hybrid neural networks can model grid behavior for predictive tasks. For example, the global network of a hybrid neural network models normal grid behavior under standard operating conditions, while local networks of the hybrid neural network detect potential failures caused by extreme weather, heavy loads, or localized disruptions. By identifying risks early, the system can automatically reroute power to prevent localized failures from escalating into widespread blackouts, enhancing the resilience of the electrical grid. As these examples demonstrate, by leveraging both global and local modeling capabilities, hybrid neural networks provide intelligent, real-time decision-making that improves system reliability, minimizes maintenance costs, and enhances operational efficiency across multiple industries.

Table 610 of FIG. 6B presents applications of adaptive hybrid neural networks according to the technology disclosed herein as applied in various fields of study. In aerodynamics, hybrid neural networks optimize airflow modeling around aircraft surfaces. The global network predicts macroscopic airflow patterns, while local networks refine turbulence modeling near critical areas such as wings, engines, and control surfaces. By integrating these insights, the hybrid neural network system can optimize wing shapes and airfoil designs to improve fuel efficiency and aerodynamic performance.

In semiconductor manufacturing, hybrid neural networks improve heat transfer simulations by analyzing both overall thermal distribution and localized hotspots. The global network simulates temperature variations across silicon wafers, while local networks focus on high-power transistor regions where excessive heat could lead to failure. Such a hybrid neural network can enable adaptive cooling mechanisms, reducing the risk of overheating and ensuring optimal performance of semiconductor devices.

For structural stress analysis in civil engineering, hybrid neural networks provide early warnings for potential structural failures. A global network models load distribution across bridges or buildings, while local networks assess microfractures and stress concentration points. By continuously monitoring these factors, the system can determine when repairs or reinforcements are needed, preventing catastrophic failures and extending infrastructure lifespan.

In biomedical engineering, hybrid neural networks improve drug diffusion simulations by modeling both systemic distribution and localized concentration effects. The global network predicts how a drug disperses throughout the human body, while local networks focus on regions with high drug accumulation, such as tumor sites. This approach enables personalized drug delivery strategies, optimizing treatment efficiency while minimizing side effects.

Tables 600 and 610 present just a few examples of applications of adaptive hybrid neural networks. Descriptions of other non-limiting examples follow.

With respect to autonomous navigation, a hybrid neural network's output with respect to autonomous vehicles by integrating global driving patterns with local, context-specific adjustments. For one example, in lane-keeping and adaptive cruise control, the global network of a hybrid neural network may be trained to predict lane markings and assess real-time vehicle proximity under optimal visibility conditions, while one or more local networks of the hybrid neural network may be trained to adapt to reduced visibility at night or during poor weather. Such a configuration allows the hybrid neural network to dynamically adjust steering and throttle to maintain safe driving conditions.

In another example, for autonomous parking, the global network of a hybrid neural network may calculate vehicle positioning for standard parking situations, while the local networks of the hybrid neural network refine positioning when dealing with tight spaces or atypical parking conditions. Training a hybrid neural network for such tasks can enable precise execution of parallel or reverse parking maneuvers.

Turning to manufacturing robotics, a hybrid neural network can be used to improve robotic grasping. For example, a global network may be trained to predict optimal gripping strategies based on an object's overall size and weight, while local networks of the hybrid neural network may be trained to make real-time adjustments based on shape, softness, and texture. At inference, the hybrid neural network can ensure a secure grip while enhancing the accuracy of robotic assembly operations.

Beyond industrial applications, hybrid neural networks can also be trained for tasks relating to enhancing computational simulations in fields such as fluid dynamics, materials science, and quantum mechanics by integrating global trends with local complexities. The use of hybrid neural networks enables more precise modeling of physical phenomena, leading to improved designs, optimized processes, and deeper scientific insights.

As the preceding examples demonstrate, by combining global insights with fine-grained local adaptations, hybrid neural networks revolutionize scientific simulations, offering more accurate predictions and facilitating innovation across diverse disciplines.

Turning now to FIG. 7, architecture 700 illustrates computing device 701 that is representative of any system or collection of systems in which the various processes, programs, services, and scenarios disclosed herein may be implemented. Examples of computing device 701 include, but are not limited to, server computers, web servers, cloud computing platforms, and data center equipment, as well as any other type of physical or virtual server machine, container, and any variation or combination thereof. Examples also include desktop and laptop computers, tablet computers, mobile computers, and wearable devices.

Computing device 701 may be implemented as a single apparatus, system, or device or may be implemented in a distributed manner as multiple apparatuses, systems, or devices. Computing device 701 includes, but is not limited to, processing system 702, storage system 703, software 705, communication interface system 707, and user interface system 709 (optional). Processing system 702 is operatively coupled with storage system 703, communication interface system 707, and user interface system 709.

Processing system 702 loads and executes software 705 from storage system 703. Software 705 includes and implements hybrid neural network process 706, which is representative of the hybrid neural network processes discussed with respect to the preceding Figures, such as process 200 and workflow 400. When executed by processing system 702, software 705 directs processing system 702 to operate as described herein for at least the various processes, operational scenarios, and sequences discussed in the foregoing implementations. Computing device 701 may optionally include additional devices, features, or functionality not discussed for purposes of brevity.

Referring still to FIG. 7, processing system 702 may comprise a micro-processor and other circuitry that retrieves and executes software 705 from storage system 703. Processing system 702 may be implemented within a single processing device but may also be distributed across multiple processing devices or sub-systems that cooperate in executing program instructions. Examples of processing system 702 include general purpose central processing units, graphical processing units, application specific processors, and logic devices, as well as any other type of processing device, combinations, or variations thereof.

Storage system 703 may comprise any computer readable storage media readable by processing system 702 and capable of storing software 705. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 703 may also include computer readable communication media over which at least some of software 705 may be communicated internally or externally. Storage system 703 may be implemented as a single storage device but may also be implemented across multiple storage devices or sub-systems co-located or distributed relative to each other. Storage system 703 may comprise additional elements, such as a controller, capable of communicating with processing system 702 or possibly other systems.

Software 705 (including hybrid neural network process 706) may be implemented in program instructions and among other functions may, when executed by processing system 702, direct processing system 702 to operate as described with respect to the various operational scenarios, sequences, and processes illustrated herein. For example, software 705 may include program instructions for implementing the hybrid neural network processes as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software, virtualization software, or other application software. Software 705 may also comprise firmware or some other form of machine-readable processing instructions executable by processing system 702.

In general, software 705 may, when loaded into processing system 702 and executed, transform a suitable apparatus, system, or device (of which computing device 701 is representative) overall from a general-purpose computing system into a special-purpose computing system customized to support hybrid neural network processes including training and run-time processing in an optimized manner. Indeed, encoding software 705 on storage system 703 may transform the physical structure of storage system 703. The specific transformation of the physical structure may depend on various factors in different implementations of this description. Examples of such factors may include, but are not limited to, the technology used to implement the storage media of storage system 703 and whether the computer-storage media are characterized as primary or secondary, etc.

For example, if the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 707 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 701 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present disclosure may be embodied as a system, method or computer program product. Accordingly, aspects of the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the disclosure is not limited to the specific implementations described above, but only by the claims and their equivalents.

Unless the context clearly requires otherwise, throughout the description and the claims, the words “comprise,” “comprising,” “such as,” and “the like” are to be construed in an inclusive sense, as opposed to an exclusive or exhaustive sense, that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having operations, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A feedback artificial intelligence (AI) system for performing a task by processing input data from an input space and mapping it to output data in an output space, the system comprising: a processor; and a memory storing instructions that, when executed by the processor, cause the system to:
collect a dataset of inputs from different regions of the input space;
execute a hybrid neural network trained to map the input data to the output data, wherein the hybrid neural network comprises:
a global neural network trained to process the input data from any region of the input space and generate corresponding output data; and
a plurality of local neural networks positioned along a processing path of the input data, wherein each local neural network is associated with a distinct partition of the input space defined by a trainable window function and wherein each local neural network processes the input data and generates corresponding output data only if the input data falls within a designated partition determined by the corresponding window function;
wherein the hybrid neural network generates the output data that integrates the output data of the global neural network and the local neural networks; and
perform the task based on the mapped output data.

2. The feedback AI system of claim 1, wherein, during training of the hybrid neural network, each window function dynamically adjusts an activation region of a corresponding local neural network within the input space, and wherein the output data of the global neural network and the output data of the plurality of local neural networks are directly combined in the output space to provide an adaptive representation of statistical relationships between the input data and the output data.

3. The feedback AI system of claim 1, wherein the hybrid neural network is trained using a loss function applied only to a final output of the hybrid neural network.

4. The feedback AI system of claim 1, wherein a combination of the trainable window functions covers only a portion of the input space.

5. The feedback AI system of claim 4, wherein the hybrid neural network is trained using a compound loss function that separately penalizes errors in the output of the global neural network and errors in the combined output of the global neural network and the local neural networks.

6. The feedback AI system of claim 4, wherein the hybrid neural network is trained using a loss function that includes a regularization term that penalizes simultaneous activation of an excessive number of local neural networks.

7. The feedback AI system of claim 1, wherein the hybrid neural network dynamically modifies its architecture during training by adjusting one or more of: a number of the local neural networks, the window functions of the plurality of the local neural networks, and parameters of the plurality of the local neural networks.

8. The feedback AI system of claim 7, wherein the training comprises
monitoring a residual error of the hybrid neural network across the input space;
adding a local neural network in a region where the residual error exceeds a first predefined threshold by initializing its window function in a center of that region; and
removing the local neural network in a region where the residual error falls below a second predefined threshold.

9. A method for adaptively training a neural network to improve performance in complex problem domains, comprising:
providing a pretrained global neural network configured to capture large-scale trends over an input space of a dataset;
computing residual errors between predictions of the global neural network and corresponding ground-truth values;
dynamically instantiating local neural networks in response to residual errors exceeding a predefined threshold, wherein each local neural network is configured to refine predictions in a corresponding region of the input space;
training the local neural networks independently or jointly with the global neural network to minimize residual errors in the corresponding regions;
adjusting a number and spatial placement of the local neural networks during training or inference based on real-time performance analysis, wherein local neural networks are removed from regions where residual errors fall below a predefined threshold; and
generating a final output by combining predictions of the global neural network and the local neural networks, wherein a contribution of each local neural network is weighted according to a dynamically trainable window function defining a spatial coverage of the respective local neural network.

10. The method of claim 9, wherein each window function dynamically adjusts an activation region of its corresponding local neural network within the input space based on the final output.

11. The method of claim 9, wherein outputs of the global neural network and the local neural networks are directly combined in an output space to provide an adaptive representation of statistical relationships between input and output data.

12. The method of claim 9, wherein the neural network is trained using a compound loss function that separately penalizes errors in the output of the global neural network encouraging it to capture dominant trends over the input space and errors in the combined output of the global neural network and the local neural networks, ensuring that the local neural networks activate only when they contribute to a significant reduction in prediction error.

13. The method of claim 9, wherein a combination of the trainable window functions of the local neural networks covers only a portion of the input space.

14. The method of claim 9, wherein the residual error includes a regularization term that penalizes simultaneous activation of an excessive number of local neural networks.

15. An adaptive neural network architecture for executing inference in a complex problem domain, the architecture comprising:
a global neural network configured to generate baseline predictions based on a dataset, or physics-based constraints, or a combination of both;
a plurality of local neural networks instantiated dynamically based on precomputed residual errors exceeding a predefined threshold, each local neural network being configured to refine predictions in a corresponding region of an input space;
a residual-based error analysis module configured to determine contributions of each local neural network by computing deviations between predictions by the global neural network and ground-truth data or a degree to which the predictions by the global neural network violate physics-based constraints;
a fusion module configured to integrate predictions from the global neural network and active local neural networks, wherein each active local neural network's contribution is weighted according to a dynamically learned window function defining its spatial and contextual relevance; and
a dynamic local network manager configured to adjust a number and spatial placement of the local neural networks during training based on the residual errors.

16. The adaptive neural network architecture of claim 15, wherein, during training of the adaptive neural network, each window function dynamically adjusts an activation region of its corresponding local neural network within the input space, and wherein outputs of the global neural network and the local neural networks are directly combined in the output space to provide an adaptive representation of statistical relationships between input and output data.

17. The adaptive neural network architecture of claim 15, wherein the adaptive neural network is trained using a compound loss function that separately penalizes errors in output of the global neural network encouraging it to capture dominant trends over the input space and errors in the combined output of the global neural networks and local neural networks, ensuring that local neural networks activate only when they contribute to a significant reduction in prediction error.

18. The adaptive neural network architecture of claim 15, wherein the complex problem domain comprises autonomous vehicle control for real-time decision-making for lane-keeping and adaptive cruise control, wherein the global neural network predicts steering and acceleration under good visibility conditions and wherein the local neural networks adjust steering and acceleration in response to decreased visibility at night or in poor weather conditions.

19. The adaptive neural network architecture of claim 15, wherein the complex problem domain comprises power grid monitoring for detecting fluctuations in electrical demand and infrastructure health, wherein the global neural network predicts network stability under normal loads or weather and wherein the local neural networks detect failures under strong loads or bad weather, enabling preventive maintenance and real-time rerouting of power.

20. The adaptive neural network architecture of claim 15, wherein the complex problem domain comprises aerospace aerodynamics modeling for high-resolution simulations, wherein the global neural network models macroscopic airflow patterns around an aircraft's body and wherein the local neural networks refine predictions in turbulence-prone areas, such as near engines, wings, and control surfaces.
